(19) United States
(12) Patent Application Publication
(10) Pub. No.: US 2026/0004532 A1
(43) Pub. Date: Jan. 1, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: MIZUKI MATSUBARA, Tokyo (JP)

(21) Appl. No.: 19/215,880

(22) Filed: May 22, 2025

(30) Foreign Application Priority Data
Jun. 26, 2024 (JP) 2024-102924

(51) Int. Cl. G06T 19/00; G02B 27/01

(52) U.S. Cl. CPC G06T 19/006; G02B 27/017

(57) ABSTRACT

In a mixed reality image using a see-through HMD, a wearer's concentration and immersion are improved. In an image processing apparatus generating a mixed reality image which is obtained by combining a real image with a virtual reality image and is displayed on a see-through captured image display device worn on a person's head, an area of the mixed reality image in which a real object seen in the real image is visible is determined based on an instruction from a wearer and the mixed reality image is generated by combining the real image with the virtual reality image according to the determined area.

### BACKGROUND

### Field

The present disclosure relates to an image processing technique for mixed reality.

### Description of the Related Art

In recent years, a technique of merging a real space with a virtual space called mixed reality (MR) has come into use. One of methods for realizing the mixed reality is a method of using a see-through head-mounted display (HMD) worn on a person's head. In an MR system using the see-through HMD, a wearer of the HMD watches a combined image obtained by superimposing a virtual reality image using computer graphics (CG) on a real image captured by a camera embedded in the HMD. The wearer can see both real and virtual objects at the same time in the combined image (hereinafter referred to as “mixed reality image”). As a scene to which such an MR system using a see-through HMD is applied, for example, there is office work using a virtual display. In this case, a wearer can carry out office work by viewing the virtual display outputting a PC screen while seeing a real keyboard or document. This eliminates the need to install a desktop display in the real space and carries the advantage that office work can be done anywhere with a large-screen virtual display. Here, in a mixed reality image which a see-through HMD wearer watches, the relationship between a real object and a virtual object is important. In this regard, there has been proposed a technique of making a virtual object transparent within a predetermined distance from a wearer and thereby solving the problem that the wearer cannot see a real object shielded behind the virtual object and may mistakenly touch the real object (see Japanese Patent Laid-Open No. 2016-4493).

Incidentally, during experience of a mixed reality image with a see-through HMD, a wearer's concentration or immersion is sometimes impaired by a person or object in a real space in the visual field. For example, in the above example of office work, it is assumed that there is a passage ahead in the eye direction of the wearer (on a line extending from the virtual display). In such an environment, persons going along the passage come within the sight, which interferes with the wearer's concentration or immersion. To avoid this, while it is necessary to display a real object the wearer wants to see such as a keyboard used for operation or the like visibly in the mixed reality image, it is preferable to hide the other real objects invisibly. Such a problem has not been addressed by the above technique of Japanese Patent Laid-Open No. 2016-4493 which makes a virtual object transparent within a predetermined distance.

### SUMMARY

An image processing apparatus according to the present disclosure is an image processing apparatus generating a mixed reality image which is obtained by combining a real image with a virtual reality image and is displayed on a see-through captured image display device worn on a person's head, the image processing apparatus comprising: one or more memories storing instructions; and one or more processors executing the instructions to: accept an instruction from a wearer who wearing the see-through captured image display; determine, based on the instruction from the wearer, an area of the mixed reality image in which a real object seen in the real image is visible; and generate the mixed reality image by combining the real image with the virtual reality image according to the determined area.

Further features of the present disclosure will become apparent from the following description of exemplary embodiments with reference to the attached drawings.

### BRIEF DESCRIPTION OF THE DRAWINGS

FIG. 1A is a diagram showing an appearance of an MR system and an example of wearing and FIG. 1B is a diagram showing a hardware configuration of an image processing apparatus;

FIG. 2 is a diagram showing a hardware configuration example of a video see-through HMD;

FIG. 3 is a functional block diagram showing a software configuration of an image processing apparatus according to a first embodiment;

FIGS. 4A and 4B are diagrams showing coordinate systems;

FIG. 5 is a flowchart showing a process flow of generation of a mixed reality image in the image processing apparatus according to the first embodiment;

FIGS. 6A and 6B are illustrative diagrams of a reference depth;

FIGS. 7A to 7C are diagrams illustrating a course of generating a mixed reality image;

FIG. 8 is a flowchart showing a process flow of generation of a mixed reality image according to Modification Example 1 of the first embodiment;

FIGS. 9A and 9B are illustrative diagrams of the reference depth;

FIGS. 10A and 10B are illustrative diagrams of the reference depth;

FIG. 11 is a functional block diagram showing a software configuration of an image processing apparatus according to a second embodiment;

FIG. 12 is a flowchart showing a process flow of generation of a mixed reality image in the image processing apparatus according to the second embodiment;

FIG. 13 is a flowchart showing a process flow of generation of a mixed reality image according to Modification Example 2 of the second embodiment;

FIG. 14 is a functional block diagram showing a software configuration of an image processing apparatus according to a third embodiment;

FIG. 15 is a flowchart showing a process flow of generation of a mixed reality image in the image processing apparatus according to the third embodiment;

FIG. 16A is a diagram showing an example of an object detection result image and FIG. 16B is a diagram showing an example of an object detection result table;

FIG. 17 is a diagram showing an example of a mixed reality image according to the third embodiment;

FIG. 18 is a functional block diagram showing a software configuration of an image processing apparatus according to a fourth embodiment;

FIG. 19 is a flowchart showing a process flow of generation of a mixed reality image in the image processing apparatus according to the fourth embodiment; and

FIG. 20 is a diagram showing an example of a display flag table.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

The first embodiment describes an aspect of setting a reference depth based on user input and generating a mixed reality image in which a real object within the reference depth is visible while a real object beyond the reference depth is invisible.

### System Configuration

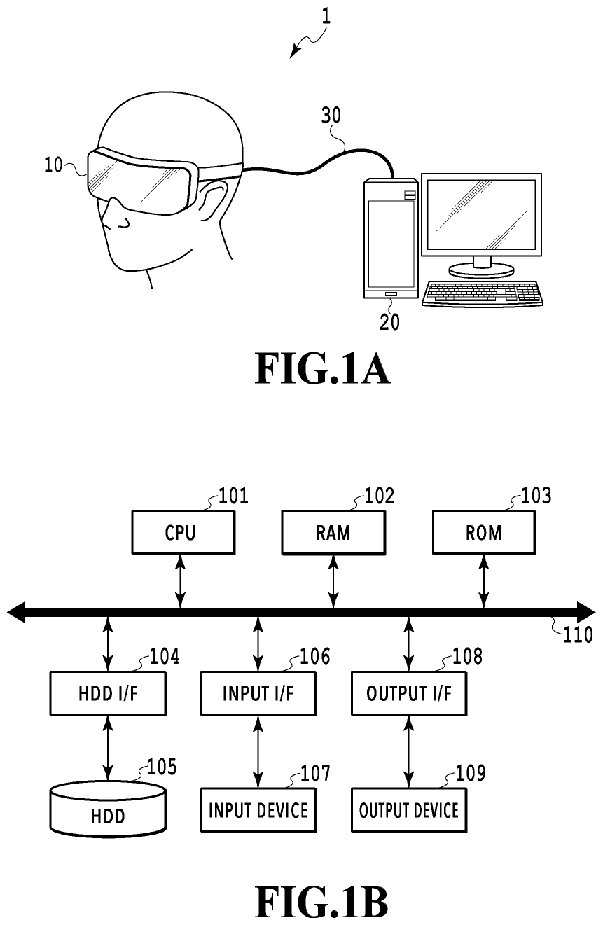

FIG. 1A is a diagram showing an appearance of an MR system which reproduces a mixed reality image and an example of wearing. An MR system 1 includes an HMD 10 which is a see-through captured image display device worn on a person's head and an image processing apparatus 20 which generates a mixed reality image where a real space is merged with a virtual space and provides the HMD 10 with the generated image. The HMD 10 and the image processing apparatus 20 are connected via a cable 30. However, the connection between the HMD 10 and the image processing apparatus 20 is not limited to a wired connection and may be a wireless connection.

### Hardware Configuration of Image Processing Apparatus

FIG. 1B is a diagram showing an example of a hardware configuration of the image processing apparatus 20. In FIG. 1B, a CPU 101 uses a RAM 102 as work memory to execute programs stored in a ROM 103 and a hard disk drive (HDD) 105 and controls operation of each block described later via a system bus 110. An HDD interface (“interface” is hereinafter referred to as “I/F”) 104 connects a secondary storage device such as the HDD 105 or an optical disk drive. The HDD I/F 104 is an I/F such as a serial ATA (SATA). The CPU 101 can read data from and write data to the HDD 105 via the HDD I/F 104. The CPU 101 can also load data stored in the HDD 105 into the RAM 102 and reversely store data loaded into the RAM 102 in the HDD 105. The CPU 101 can execute data loaded into the RAM 102 as a program. An input I/F 106 connects an input device 107 such as a keyboard or mouse. The input I/F 106 is a serial bus I/F such as a USB or IEEE 1394. The CPU 101 can read an operation signal of the input device 107 or the like via the input I/F 106. An output I/F108 connects an output device 109 such as the HMD 10 or a liquid crystal display device. The output I/F108 is a video output I/F such as a DVI or HDMI (registered trademark). The CPU 101 can send video data via the output I/F108 and cause the HMD 10 or the liquid crystal display device to display a predetermined video.

### Hardware Configuration of HMD

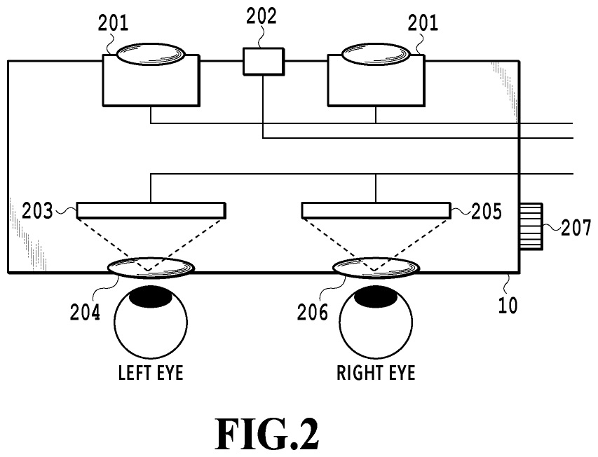

FIG. 2 is a diagram showing a hardware configuration example of the video see-through HMD 10. The HMD 10 comprises a plurality of RGB cameras 201 and an unshown inertial measurement unit (IMU) to implement inside-out position tracking. The IMU is a device to detect three-dimensional inertial motion (rotational motion and translational motion in straight 3-axis directions) and includes a gyro sensor to capture rotational motion and an acceleration sensor to capture translational motion. The HMD 10 further comprises a distance sensor 202 such as a light detection and ranging (LiDAR) sensor to obtain depth information. There are also comprised a left-eye display 203 and a right-eye display 205 each formed by a liquid crystal panel or an organic EL panel to display a left-eye image and a right-eye image. Further, a left-eye eyepiece lens 204 and a right-eye eyepiece lens 206 are arranged in front of the respective displays 203 and 205. A wearer views enlarged virtual images displayed for left and right eyes through the lenses 204 and 206, respectively. The HMD 10 generates a left-eye image and a right-eye image based on a mixed reality image provided by the image processing apparatus 20 and displays the left-eye image on the left-eye display 203 and the right-eye image on the right-eye display 206. At this time, suitable parallax is provided between the left-eye image and the right-eye image, whereby a wearer can perceive a video with depth perception. The HMD 10 also comprises a dial 207 to accept a wearer's operation instruction. Incidentally, although there are constitutional elements of the HMD 10 other than the above, they are irrelevant to the main point of the present disclosure and therefore not described herein.

### Software Configuration of Image Processing Apparatus

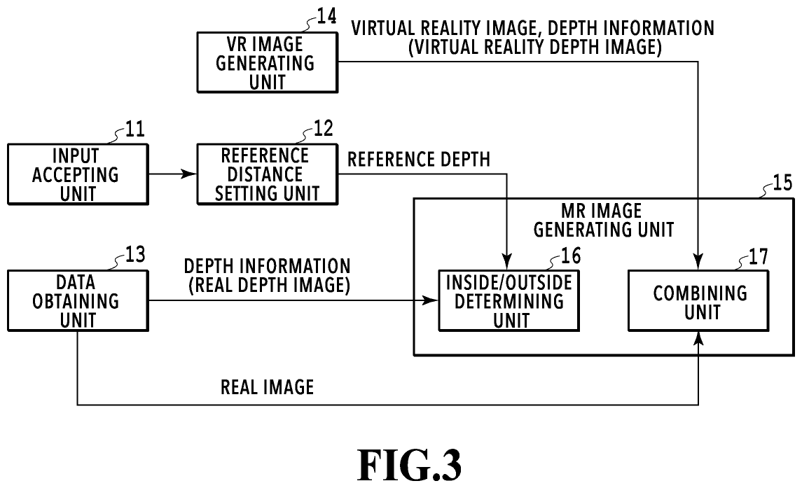

FIG. 3 is a functional block diagram showing a software configuration (logical configuration) of the image processing apparatus 20 according to the present embodiment. In FIG. 3, the image processing apparatus 20 comprises an input accepting unit 11, a reference distance setting unit 12, a data obtaining unit 13, a VR image generating unit 14, and an MR image generating unit 15. The MR image generating unit 15 comprises an inside/outside determining unit 16 and a combining unit 17. Each of the units is described below.

The input accepting unit 11 accepts various kinds of input operation (user input) by a wearer of the HMD 10. Information on the accepted user input is output to the reference distance setting unit 12.

The reference distance setting unit 12 sets a distance (hereinafter referred to as “reference depth”) used as a reference to allow a real object to be visible in a mixed reality image. The set reference depth is output to the inside/outside determining unit 16.

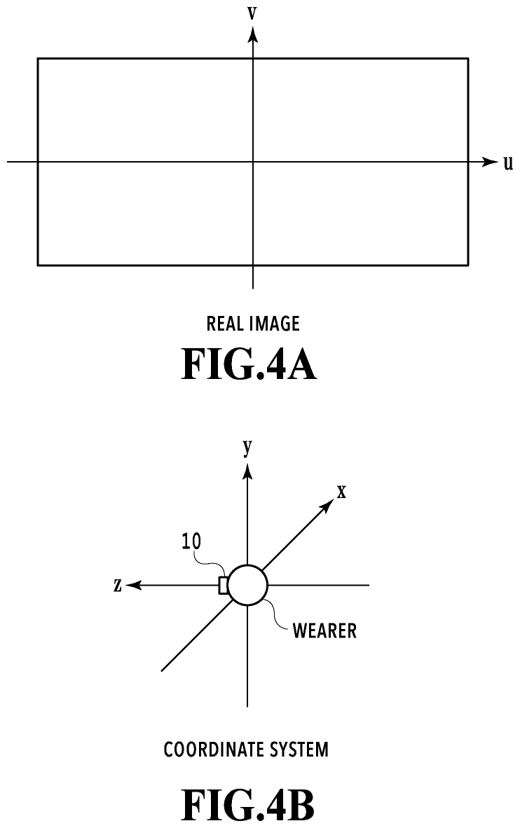

The data obtaining unit 13 obtains data on a real image from the HMD 10. As shown in FIG. 4A, each pixel position of the real image is specified by an uv coordinate system where a horizontal direction and a vertical direction are denoted by u and v, respectively, and it is assumed that the number of pixels in the u direction (width) is w and the number of pixels in the v direction (height) is h. Each pixel of the real image has color value data with three channels of red, green, and blue (RGB value having 8 bits for each channel). The data obtaining unit 13 also obtains from the HMD 10 depth information indicating a distance between a wearer (˜ HMD 10) and a real object in a real space. In the present embodiment, data on an image (hereinafter referred to as “real depth image”) equal in number of pixels to the real image is obtained as the depth information. In each pixel of the real depth image, a value read by the distance sensor 202 is stored, the value being a distance value (in units of m) to a real object seen in the same pixel position in the real image. FIG. 4B shows a coordinate system of a distance indicated by each pixel of the real depth image. The present embodiment uses a so-called camera coordinate system having its center at the wearer of the HMD 10, z axis in the forward direction, y axis in the vertical direction, and x axis in the horizontal direction. That is, a distance expressed by the real depth image is a distance (unit: m) from the origin on the assumption that the wearer of the HMD 10 is the origin. Incidentally, the real depth image may be generated/obtained by applying a well-known stereo matching technique to the obtained real image instead of using the distance sensor 202. Stereo matching is the method of obtaining a three-dimensional position of a subject according to the principle of triangulation from differences in the subject seen in image data obtained from two image capturing devices at different positions. Through the stereo matching, three-dimensional coordinates of a real object seen in each pixel are obtained for all the pixels of the real image. A coordinate system used here is a camera coordinate system having the origin of the three-dimensional coordinate system at the center of the head of the HMD wearer. In the case of stereo matching, on the assumption that three-dimensional coordinates of a point of a real object seen in a pixel (u′, v′) are (x′, y′, z′), a Euclidean distance represented by the following expression (1) is stored in the position of the pixel (u′, v′) of the real depth image. A depth image is obtained by performing this process for all the pixels.

$$\sqrt{{x}^{′ 2} + {y}^{′ 2} + {z}^{′2}} \qquad Expression ( 1 )$$

Data on the real image thus obtained is output to the combining unit 17 and data on the real depth image which is the depth information is output to the inside/outside determining unit 16.

The VR image generating unit 14 generates a virtual reality image expressing a virtual object such as a virtual display. The VR image generating unit 14 also generates a depth image (hereinafter referred to as “virtual reality depth image”) in which distance values are stored in pixels corresponding to the respective pixels of the virtual reality image as depth information indicating a distance to the virtual object expressed by the virtual reality image. Like the real depth image, a width w and a height h of the virtual reality depth image are equal to the width w and the height h of the real image. Data on the generated virtual reality image and virtual reality depth image is output to the combining unit 17.

The MR image generating unit 15 includes the inside/outside determining unit 16 and the combining unit 17 and generates a mixed reality image which is a result of combining the real image with the virtual reality image. A width w and a height h of the mixed reality image are equal to the width w and the height h of the real image.

The inside/outside determining unit 16 determines based on the real depth image whether the real object seen in the real image is within the reference depth (whether the real object exists inside or outside the boundary indicated by the reference depth). The result of determination is output to the combining unit 17.

The combining unit 17 generates a mixed reality image by combining the real image with the virtual reality image such that a real object determined by the inside/outside determining unit 16 to exist within the reference depth is visible and a real object determined to exist beyond the reference depth is invisible. Data on the generated mixed reality image is transmitted to the HMD 10. This is the end of the description of the software configuration (logical configuration) of the image processing apparatus 20. Operation Flow of Image processing apparatus

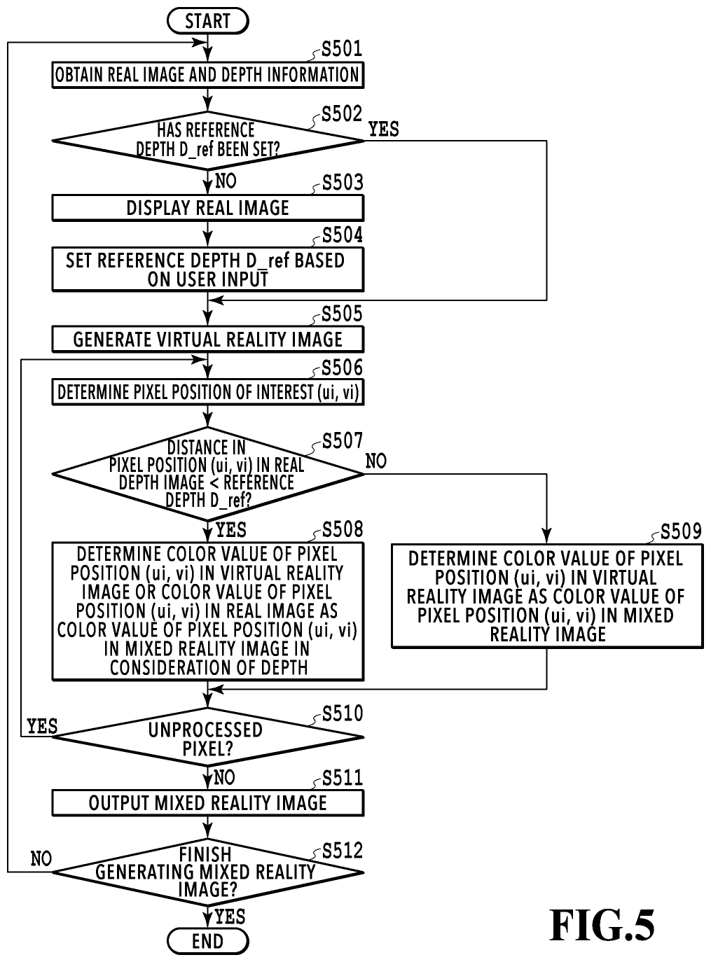

FIG. 5 is a flowchart showing a process flow of generation of a mixed reality image in the image processing apparatus 20 according to the present embodiment. A series of processes shown in the flowchart of FIG. 5 is executed for each frame. A detailed description is provided below with reference to the flowchart of FIG. 5. Incidentally, sign “S” means a step in the following description.

In S501, the data obtaining unit 13 obtains from the HMD 10 data on a real image obtained by capturing a real space with the RGB cameras 201 and a real depth image obtained by measuring the same real space with the distance sensor 202.

In S502, a process to be executed next is determined according to whether a reference depth D_ref has been set for a mixed reality image to be generated. In a case where the reference depth D_ref has not been set, the process advances to S503 and the real image obtained in S501 is displayed on the two displays 203 and 205 of the HMD 10. In contrast, in a case where the reference depth D_ref has been set, S505 is executed next. Incidentally, even in a case where the reference depth D_ref has been set, the setting of the reference depth D_ref may be made again upon new detection of user input described later in S504.

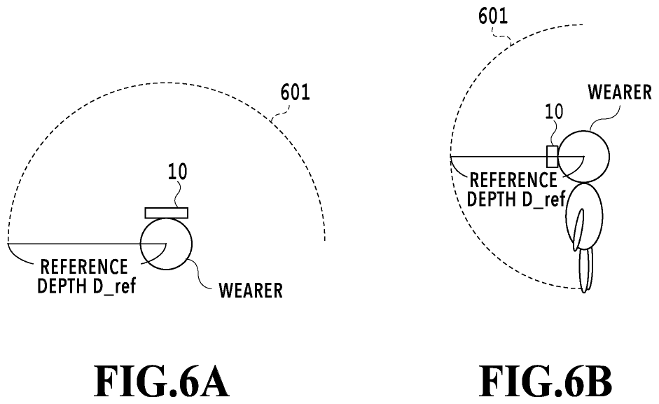

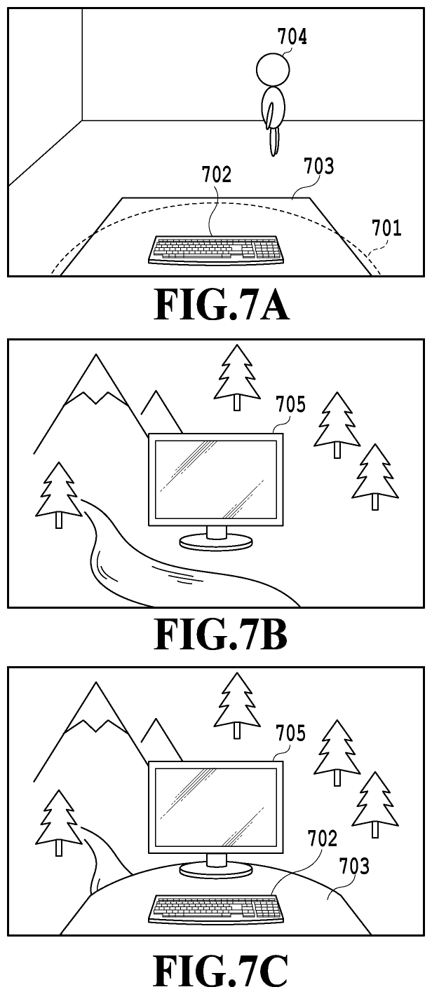

In S504, the reference distance setting unit 12 sets based on user input a reference depth D_ref which is a distance to allow display of a real object in a mixed reality image to be generated. In the present embodiment, the reference depth D_ref is set according to a user instruction accepted via the input accepting unit 11, more specifically a value (input value) of an amount of rotation of the dial 207 in a case where the wearer rotates the dial 207 installed on the HMD 10. The wearer operates the dial 207 while seeing the real image displayed on the two displays 203 and 205 of the HMD 10. For example, it is assumed that the dial 207 allows a setting of an arbitrary distance in a range between 0 and 10 m (the minimum input value corresponds to a distance of 0 m and the maximum value of the amount of rotation corresponds to a distance of 10 m). In this case, a distance corresponding to the input value of the dial 207 by the wearer is set as the reference depth D_ref. Further, the distances corresponding to the minimum and maximum values of the amount of rotation of the dial 207 may be variable depending on the size of the real space. In this case, a distance M between the HMD 10 and a wall is first obtained through a wall detection technique using well-known machine learning or the like. Next, it is only necessary to calculate the distance M÷the maximum value of the amount of rotation×the input value of the dial to make a conversion into a distance corresponding to the input value of the dial and set the reference depth D_ref. FIGS. 6A and 6B are illustrative diagrams of the reference depth D_ref according to the present embodiment showing a range equidistant from the center of the wearer's head. FIG. 6A is a plan view and FIG. 6B is a side view. In both of the drawings, a broken line 601 shows the reference depth D_ref. After the completion of the above process, each of the subsequent processes S505 to S510 is executed by the MR image generating unit 15. Incidentally, while the wearer performs the operation for setting the reference depth, the user may be allowed to check the range of the reference depth according to the operation. Specifically, a method of superimposing a line indicating the reference depth (see a broken line 701 in FIG. 7A described later) on the real image or color-coding the areas of the real image within and beyond the reference depth is considered.

In S505, the VR image generating unit 14 generates a virtual reality image and depth information (virtual reality depth image) indicating a distance to a virtual object seen in the virtual reality image. Specifically, information prepared in advance such as a shape, texture, position, and orientation of the virtual object is read from the HDD 105 or the like and the virtual reality image and the corresponding virtual reality depth image are generated using this information through a well-known rendering technique. Here, as the information on the position and orientation of the virtual object, for example, information that the virtual object is arranged at the position 2 m in front of the HMD 10 to face the wearer is set in advance. However, the virtual reality image and the virtual reality depth image may be generated/stored in advance and read from the HDD 105.

In S506, a pixel position of interest in the real image obtained in S501 is determined. Here, image coordinates of the pixel position of interest are denoted by (ui, vi). Prior to the determination of the pixel position of interest, a process of securing in the RAM 102 or the like a buffer to temporarily store data on the mixed reality image in progress is also executed.

In S507, the inside/outside determining unit 16 determines whether a real object seen in the pixel position of interest (ui, vi) exists within or beyond the reference depth D_ref set in S504. Specifically, a pixel value (distance value in units of m) stored in the pixel position of interest (ui, vi) in the real depth image obtained in S501 is compared with the value of the set reference depth D_ref to determine whether the value of the reference depth D_ref is greater. In FIGS. 6A and 6B described above, the inside of the broken line 601 viewed from the wearer of the HMD 10 is a range within the reference depth D_ref. As a result of determination, in a case where the pixel value stored in the pixel position of interest (ui, vi) in the real depth image is equal to or less than the value of the reference depth D_ref, S508 is executed next. In a case where the pixel value stored in the pixel position of interest (ui, vi) in the real depth image is greater than the value of the reference depth D_ref, S509 is executed next.

In S508, the combining unit 17 determines a color value in the pixel position of interest (ui, vi) in the mixed reality image through a process of combining the real image with the virtual reality image in consideration of the depth relationship between the real object and the virtual object in the wearer's eye direction (depth-considered combining process). In the depth-considered combining process, out of the real object seen in the pixel position of interest (ui, vi) in the real image and the virtual object seen in the pixel position of interest (ui, vi) in the virtual reality image, an object in front of the other in the view from the wearer of the HMD 10 is rendered. A specific content of the process is as follows. First, a distance value of the pixel position of interest (ui, vi) in the real depth image is compared with a distance value of the pixel position of interest (ui, vi) in the virtual reality depth image. In a case where the distance value of the pixel position of interest (ui, vi) in the real depth image is less, a color value of the pixel position of interest (ui, vi) in the real image is stored as a color value of the pixel position of interest (ui, vi) in the mixed reality image in progress in the buffer. In contrast, in a case where the distance value of the pixel position of interest (ui, vi) in the virtual reality depth image is less, a color value of the pixel position of interest (ui, vi) in the virtual reality image is stored as a color value of the pixel position of interest (ui, vi) in the mixed reality image in progress in the buffer. In a case where the distance values are equal to each other, it is only required that which of the color value of the real image and the color value of the virtual reality image should be adopted be determined in advance and the process be performed according to the determination.

In S509, the combining unit 17 determines a color value of the pixel position of interest (ui, vi) in the mixed reality image through the process of combining the real image with the virtual reality image such that the real object is invisible and only the virtual object is visible. In this combining process, the virtual object seen in the pixel position of interest (ui, vi) in the virtual reality image is always rendered. As a specific content of the process, a color value of the pixel position of interest (ui, vi) in the virtual reality image is stored as a color value of the pixel position of interest (ui, vi) in the mixed reality image in progress in the buffer.

In S510, it is determined whether all the pixels of the real image obtained in S501 have been processed. As a result of determination, in a case where there is an unprocessed pixel, the process returns to S506 and the next pixel position of interest (ui, vi) is determined, followed by the same process. In contrast, in a case where all the pixels have been processed, S511 is executed next. FIGS. 7A to 7C are diagrams illustrating a mixed reality image obtained by the present embodiment. FIG. 7A shows a real image, FIG. 7B shows a virtual reality image, and FIG. 7C shows a mixed reality image obtained by combining the real image of FIG. 7A with the virtual reality image of FIG. 7B. The real image of FIG. 7A shows a desk 703 topped with a keyboard 702 and a passersby 704 ahead. The broken line 701 is shown to illustrate the reference depth D_ref which is actually not seen in the real image. The virtual reality image of FIG. 7B shows (renders) a virtual display 705 with nature scenery as a virtual background. In the flow of FIG. 5 described above, the combining process is executed such that either one of the real object and the virtual object present in front of the other is rendered based on the depth information within the reference depth D_ref and the virtual object is rendered irrespective of the depth information beyond the reference depth D_ref. That is, of the real objects seen in the real image of FIG. 7A, a real object present beyond the reference depth D_ref shown by the broken line 701 is not rendered. As a result, in an image area of the mixed reality image of FIG. 7C corresponding to a distance greater than the reference depth D_ref, the virtual display 705 and the virtual nature scenery are rendered and the passersby 704 in the real space is not rendered. On the other hand, in an image area of the mixed reality image of FIG. 7C corresponding to a distance less than the reference depth D_ref, either one of the real and virtual objects less than the other in distance value is rendered. Accordingly, the keyboard 702 and part of the desk 703 which are close and a stand for the virtual display 705 which is closer than the desk 703 are rendered (the distant virtual background is not rendered).

In S511, data on the mixed reality image obtained through the above process is transmitted/output to the HMD 10. In the HMD 10, a left-eye image and a right-eye image are generated based on the mixed reality image and displayed on the two displays 203 and 205, respectively.

In S512, it is determined whether to finish generating the mixed reality image. For example, in a case where a press of an end button (not shown) provided in the HMD 10 or the removal of the HMD 10 from the wearer is detected, the generation of the mixed reality image is finished. in a case where the finish of the generation is determined, this flow exits. In contrast, in a case where the generation is continued, the process returns to S501 and continues.

The above is the process flow of generation of the mixed reality image in the image processing apparatus 20 according to the present embodiment. The above process enables the wearer of the HMD 10 to view a real-time mixed reality video.

### Modification Example 1

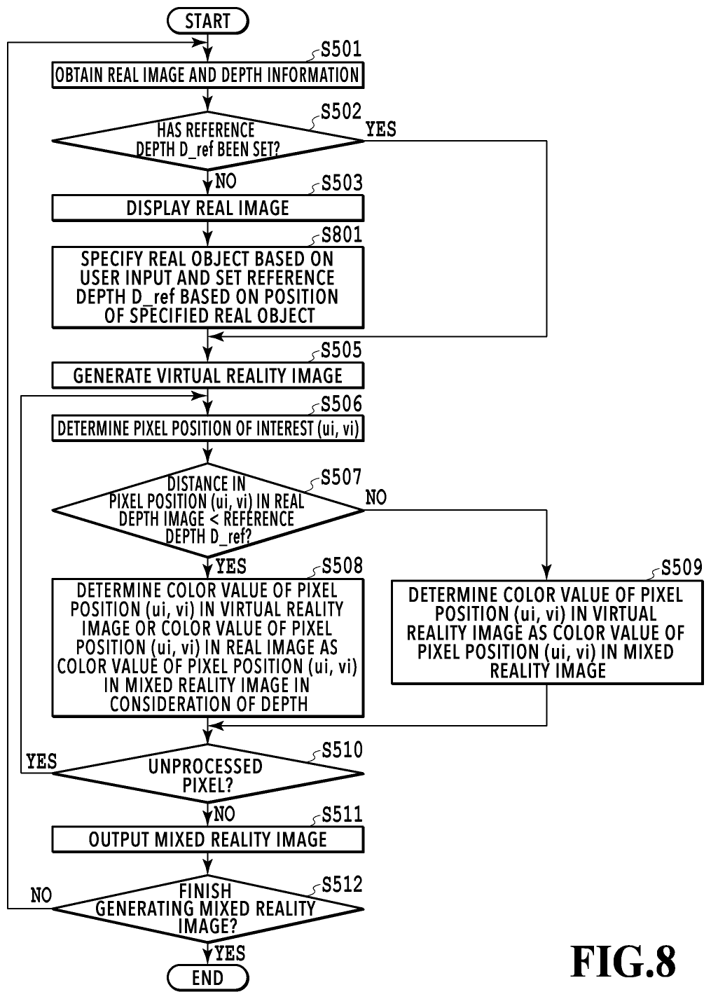

In the above embodiment, a user directly sets the reference depth. However, a user may indirectly set the reference depth by specifying a real object. In this case, since the reference depth is automatically set again depending on a distance to a real object even in a case where the position of the real object is changed, time and trouble to set the reference depth again can be saved. FIG. 8 is a flowchart showing a process flow of generation of a mixed reality image according to the present modification example. A difference from the flowchart of FIG. 5 is that S801 is executed instead of S504 and the other common steps are denoted by the same numbers. S801 making the difference is described below.

In S801, the reference distance setting unit 12 estimates a three-dimensional position of a specific real object based on user input and sets a distance to the obtained three-dimensional position as the reference depth D_ref. Specifically, the input accepting unit 11 first accepts user input to designate a real object. In this case, as the method of designation, any method can be adopted; for example, a wearer may point a specific real object with the wearer's finger or stick or a dedicated controller may be used. Next, a well-known machine learning technique is applied to the real image obtained in S501 to obtain a three-dimensional direction vector pointed with the wearer's finger or the like. Next, a well-known ray tracing technique is used to emit rays along the estimated direction vector and estimate a three-dimensional position of the real object at which the rays hit. After that, a distance between the estimated three-dimensional position of the real object and the wearer is obtained and the obtained distance is set as the reference depth. The reference depth D_ref thus set is used to execute each of the steps subsequent to S505.

Incidentally, the position of the real object necessary for ray tracing only has to be calculated by, for example, the aforementioned stereo matching technique. Here, immediately after a user designates the real object, a distance coming out of the three-dimensional position of the real object estimated based on the designation can be used as the reference depth without any change. On the other hand, the relative positional relationship between the wearer and the real object may be changed by the wearer's motion or the movement of the real object by the wearer. In this case, it is only required that a well-known object tracking technique such as particle filtering be used to estimate the three-dimensional position of the real object. Further, even in a case where the real object has already been designated, S801 may be executed again in response to the wearer's input to designate the real object again.

Further, instead of the method of designating the direction of the real object, for example, a name of a target real object may be input via a keyboard or mouse and the real object may be detected by a well-known object detection technique. In this case, a distance to the real object detected by object detection is set as the reference depth. For example, object detection per frame makes it possible to update the distance to the target real object and comply with the motion of the wearer or the real object. Further, in a case where a real object has a wireless communication function such as Bluetooth, a distance to the real object may be obtained by a well-known distance calculation method based on wireless communications (such as radio field intensity) and used as the depth information. At this time, a user may select a specific real object from a listing of Bluetooth-connected real objects and a distance to the selected real object may be obtained. Incidentally, instead of a user's selection, for example, the farthest real object may be automatically selected from the Bluetooth-connected devices and a distance to this real object may be set as the reference depth.

Further, designation of a plurality of real objects may be accepted and a distance to the farthest real object of the designated real objects may be set as the reference depth.

### Modification Example 2

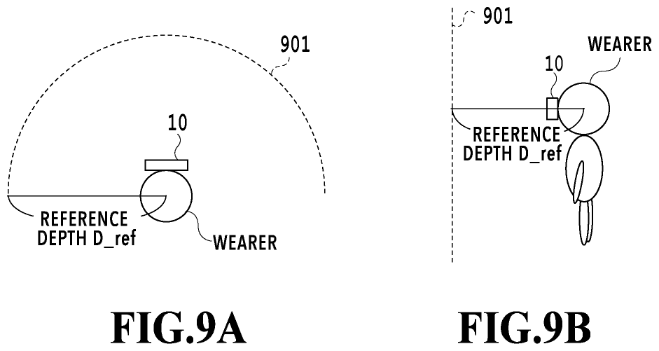

In the above embodiment, the distance indicated by the reference depth is a distance in each of the x, y, and z axes. However, a wearer's concentration or immersion is decreased mainly by a real object in the horizontal direction and is less affected by a real object in the vertical direction (y axis direction). For example, in the above example of office work, a passersby or the like annoying a wearer causes a problem only in the xz plane, while there are only the floor and ceiling in the vertical direction and such real objects rarely feel annoying. Thus, the distance indicated by the reference depth may be a distance in the x and z axes (distance in the xz plane). The reference depth D_ref in this case is shown by a broken line 901 in the plan view of FIG. 9A and the side view of FIG. 9B. In this case, on the assumption that three-dimensional coordinates of a real object seen in a pixel position (u′, v′) are (x′, y′, z′), a Euclidean distance represented by the following expression (2) is obtained. The process of storing the obtained Euclidean distance in the pixel position (u′, v′) is repeated for all the pixels to obtain a real depth image and a virtual reality depth image.

$$\sqrt{{x}^{′ 2} + {z}^{′2}} \qquad Expression ( 2 )$$

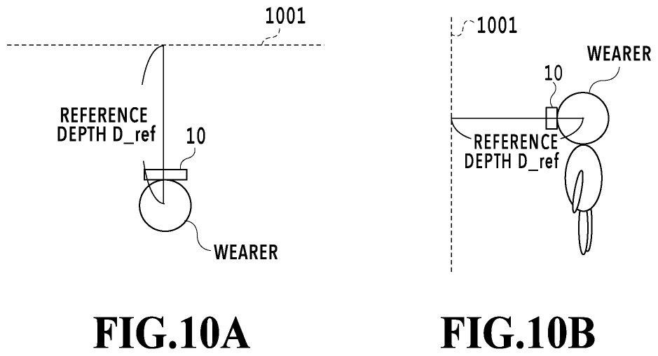

Further, the distance indicated by the reference depth may be a distance in the z axis (depth component alone). The reference depth D_ref in this case is shown by a broken line 1001 in the plan view of FIG. 10A and the side view of FIG. 10B. In this case, on the assumption that three-dimensional coordinates of a real object seen in a pixel position (u′, v′) are (x′, y′, z′), a Euclidean distance represented by the following expression (3) is obtained. The process of storing the obtained Euclidean distance in the pixel position (u′, v′) is repeated for all the pixels to obtain a real depth image and a virtual reality depth image.

$$\sqrt{{z}^{′2}} \qquad Expression ( 3 )$$

### Modification Example 3

In the above embodiment, the reference depth is set based on a wearer's dial operation of the HMD 10. However, the dial operation may be replaced with operation of other hardware such as a button or touch panel, or a wearer's hand gesture. Further, a numerical value (distance value) in units of m may be directly input via a keyboard or the like. In this case, the input numerical value is stored in the RAM 102 or the like and read in use to save the need for a wearer to input the numerical value for each frame. Incidentally, an arbitrary numerical value such as 1.0 (m) is set as an initial value such that a mixed reality image can be generated without waiting for a wearer's input. Further, the process of S503 may be provided as a different thread by a multithreading technique such that a mixed reality image is displayed while a wearer is inputting.

### Modification Example 4

In S507, the combining is performed in consideration of the depth information in units of pixels such that either one of the real object and the virtual object in front of the other is displayed. However, for example, all real objects within the reference depth may be rendered. In this case, in order to avoid a virtual object such as a virtual display from being shielded behind a real object and not being rendered, it is necessary to place the virtual object beyond the reference depth.

As described above, according to the present embodiment, the reference depth is set based on user input and a mixed reality image is generated such that a real object within the reference depth is visible while a real object beyond the reference depth is invisible. This can improve the HMD wearer's immersion and concentration.

### Second Embodiment

In recent years, a system allowing an HMD wearer to move a position of a virtual object arbitrarily in a mixed reality image has also entered widespread use. For example, in the aforementioned example of office work, it is considered that a user manually adjusts a position looks as if the virtual display actually exists on the desk. In a case where the method of the first embodiment described above is applied to such a system, a user should take the trouble to make settings of the reference depth and the position of the virtual object separately. Thus, an aspect of allowing a setting of a position of a virtual object and then automatically setting a reference depth based on the set position of the virtual object is described as the second embodiment. Incidentally, since the hardware configurations of the HMD 10 and the image processing apparatus 20 and the like are the same as those of the first embodiment, the description thereof is omitted and a difference is mainly described below.

### Software Configuration of Image Processing Apparatus

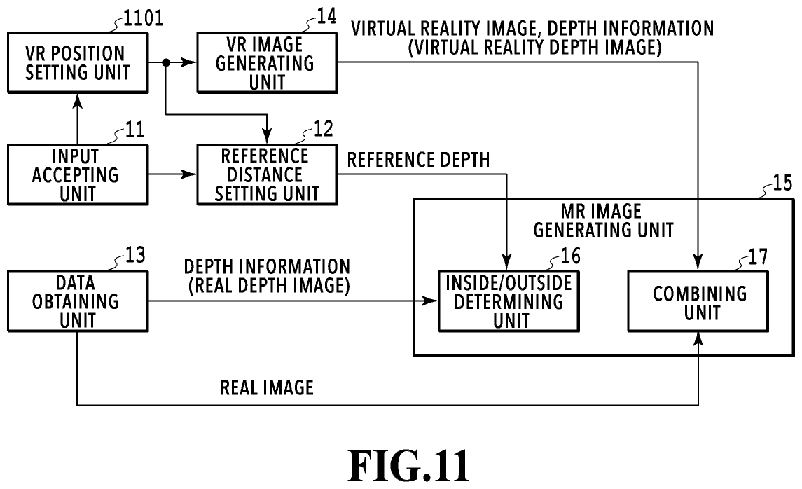

FIG. 11 is a functional block diagram showing a software configuration (logical configuration) of the image processing apparatus 20 according to the present embodiment. A major difference from the functional block diagram of FIG. 3 of the first embodiment is that a VR position setting unit 1101 is added. The VR position setting unit 1101 sets a position of a virtual object to be rendered in a virtual reality image and a mixed reality image based on user input. The set positional information on the virtual object is output to the VR image generating unit 14 and the reference distance setting unit 12.

### Operation Flow of Image Processing Apparatus

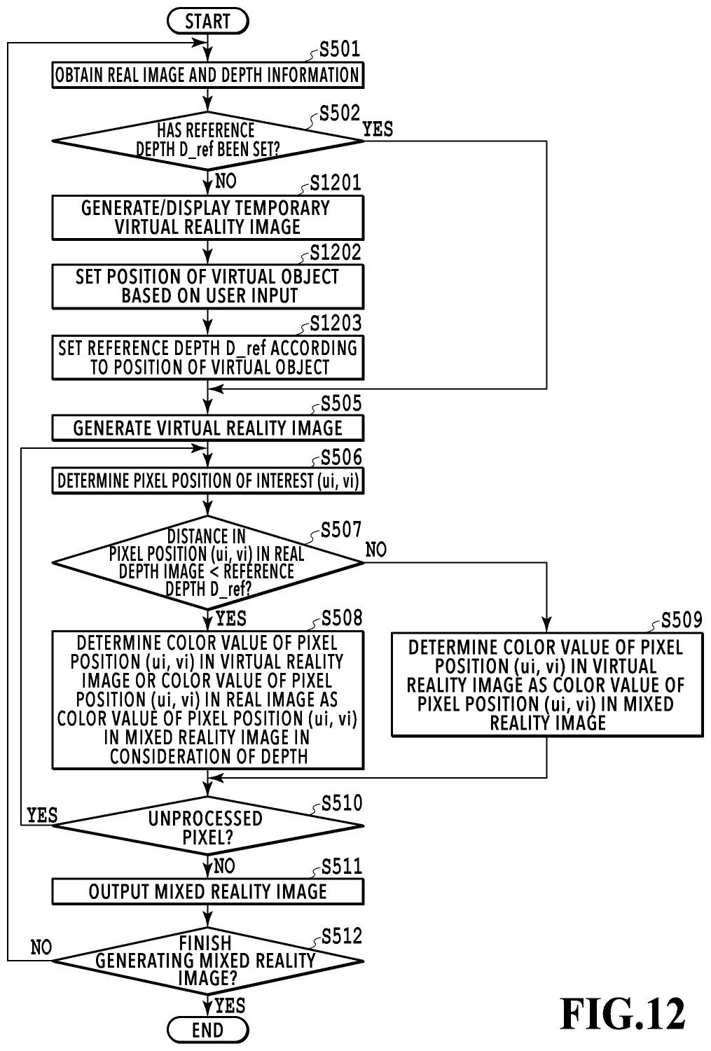

FIG. 12 is a flowchart showing a process flow of generation of a mixed reality image in the image processing apparatus 20 according to the present embodiment. A difference from the flowchart of FIG. 5 of the first embodiment is that S1201 to S1203 are executed instead of S503 and S504 and the other common steps are denoted by the same numbers. S1201 to S1203 making the difference are described below.

In S1201, the VR image generating unit 14 reads data stored in a custom depth buffer and generates a temporary virtual reality image. Here, the custom depth buffer is an image buffer referred to in execution of rendering. The custom depth buffer stores depth information indicating a distance to a virtual object (in a virtual reality image, a distance value of a portion in which a virtual object is seen is stored in pixels in which the virtual object is seen and “NULL” meaning zero is stored in the other pixels). The VR image generating unit 14 reads an initial value of the custom depth buffer prepared in advance from the HDD 105 or the like and performs rendering to generate a temporary virtual reality image in which a virtual object such as a virtual display is rendered in a default position. Data on the generated temporary virtual reality image is sent to the HMD 10 and displayed on the two displays 203 and 205 of the HMD 10.

In S1202, the VR position setting unit 1101 sets a position of a virtual object based on user input concerning the virtual object seen in the temporary virtual reality image. Here, a case where the virtual object is a virtual display is described as an example. First, a wearer makes a motion of picking up the virtual display seen in the virtual reality image with the wearer's hand and such a hand gesture as to drag and drop the virtual display to an arbitrary desirable position. The input accepting unit 11 detects the above wearer's hand gesture by a well-known machine learning technique or the like and sets a position of the virtual display in conformity with a change of the hand position (Δx_{hand}, Δy_{hand}, Δz_{hand}) by a well-known hand tracking technique. Here, on the assumption that a position of the virtual object before the change of the virtual display is (x_{before}, y_{before}, z_{before}) and a position of the virtual display after the position change is (x_{after}, y_{after}, z_{after}), the position of the virtual position is represented by the following expression (4):

$$( \begin{matrix}{x}_{after} \\ {z}_{after} \\ {z}_{after}\end{matrix} ) = ( \begin{matrix}{x}_{before} \\ {z}_{before} \\ {z}_{before}\end{matrix} ) + ( \begin{matrix}Δ {x}_{hand} \\ Δ {y}_{hand} \\ Δ {z}_{hand}\end{matrix} ) \qquad Expression ( 4 )$$

Incidentally, in a case where a wearer does not make a hand gesture or the like and the input accepting unit 11 cannot detect user input, the change of the hand position is zero and the current position of the virtual object (default position) is maintained without any change.

In S1203, the reference distance setting unit 12 sets a reference depth D_ref based on the position of the virtual object set in S1202. Specifically, the aforementioned data stored in the custom depth buffer is referred to, a distance between the wearer and the virtual object is obtained, and the obtained distance is set/derived as the reference depth D_ref. To obtain the distance, it is only necessary to obtain a minimum value, average value, median value, most frequent value, representative value, or the like in the data stored in the custom depth buffer. For example, in the case of obtaining the shortest distance, it is only necessary to scan values stored in the custom depth buffer and obtain the smallest value. The distance to the virtual object thus obtained is set as the reference depth D_ref. The reference depth D_ref set in this manner is used to execute each of the steps subsequent to S505.

Incidentally, although the distance derived from the values stored in the custom depth buffer is directly set as the reference depth D_ref in S1203 above, for example, a buffer may be provided. Further, a wearer may be allowed to adjust the derived distance. For example, the obtained distance may be temporarily displayed on the two displays 203 and 205 of the HMD 10 and a value corresponding to a wearer's input operation of the dial 207 or the like may be added to or subtracted from the obtained distance, thereby obtaining the reference depth D_ref. This enables the wearer to adjust as intended the value of the reference depth automatically derived from the position of the virtual object. Modification Example 1

In the present embodiment, a virtual object is set in an arbitrary position based on a wearer's instruction and a distance to the set position is used as the reference depth D_ref. Alternatively, for example, a line or mark indicating the reference depth may be rendered as a virtual object (see the broken line 701 in FIG. 7A described above). In this case, it is essential only that a distance to the line, mark, or the like be derived based on a hand gesture or the like for the line, mark, or the like to set the reference depth D_ref.

### Modification Example 2

In the above embodiment, the reference depth is automatically set based on a position of a virtual object designated by a user. The position of the virtual object for automatically setting the reference depth may be automatically set based on a position of a real object a user wants to see in the mixed reality image and the reference depth may be automatically set based on the position of the virtual object.

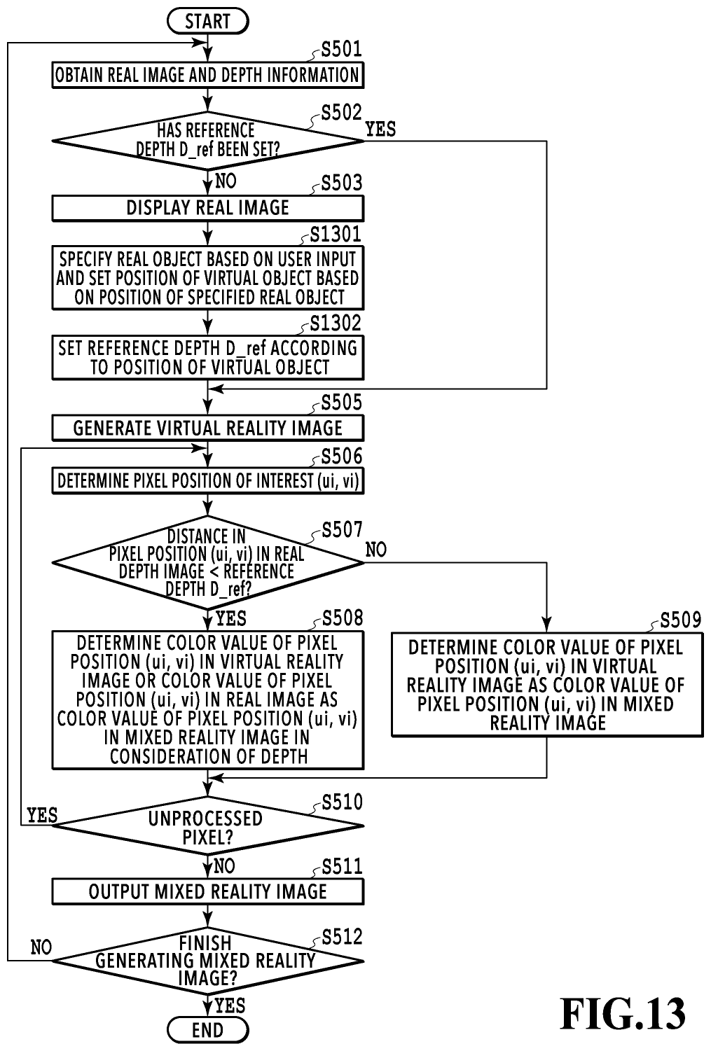

FIG. 13 is a flowchart showing a process flow of generation of a mixed reality image in the image processing apparatus 20 according to the present modification example. A difference from the flowchart of FIG. 12 described above is that S1301 and S1302 are executed following the execution of S503 instead of S1201 to S1203 and the other common steps are denoted by the same numbers. Only the difference is described below.

In S503, the real image obtained in S501 is displayed on the two displays 203 and 205 of the HMD 10.

In S1301, the reference distance setting unit 12 estimates a three-dimensional position of a specific real object based on user input and sets a position of a virtual object based on the obtained three-dimensional position. Specifically, the input accepting unit 11 first accepts user input to designate a real object. Here, the method of designating the real object and the method of estimating its three-dimensional position are as described in S801 of Modification Example 1 of the first embodiment. After that, a predetermined position ahead of the estimated three-dimensional position of the real object is set as a position of the virtual object. As the predetermined position in this case, for example, a position 0.1 m away from the three-dimensional position of the real object in the z-axis direction is defined in advance.

In S1302, the reference distance setting unit 12 sets a reference depth according to the position of the virtual object set in S1301. Specifically, a distance between the estimated three-dimensional position of the virtual object and the wearer is obtained and the obtained distance is set as the reference depth. The reference depth D_ref thus set is used to execute each of the steps subsequent to S505. This is the end of the content of the present modification example.

As described above, according to the present embodiment, the reference depth is automatically set according to a position of a virtual object set based on user input. This can save the trouble to set the position of the virtual object and the reference depth separately.

### Third Embodiment

In a mixed reality image generated by the methods of the first and second embodiments, a real object or a virtual object is displayed through depth-considered combining within the reference depth and a virtual object is displayed beyond the reference depth. Accordingly, display of a real object at the boundary of the reference depth is broken in midstream (for example, in FIG. 7C described above, the farthest corners of the desk 703 are cut away and replaced with the virtual background), which results in an unnatural mixed reality image. Thus, an aspect of entirely displaying a real object which is partially within the reference depth is described as the third embodiment. Incidentally, since the hardware configurations of the HMD 10 and the image processing apparatus 20 and the like are the same as those of the first and second embodiments, the description thereof is omitted and a difference is mainly described below. Further, although a difference on the basis of the second embodiment is described below, it is also applicable on the basis of the first embodiment (including the modification examples).

### Software Configuration of Image Processing Apparatus

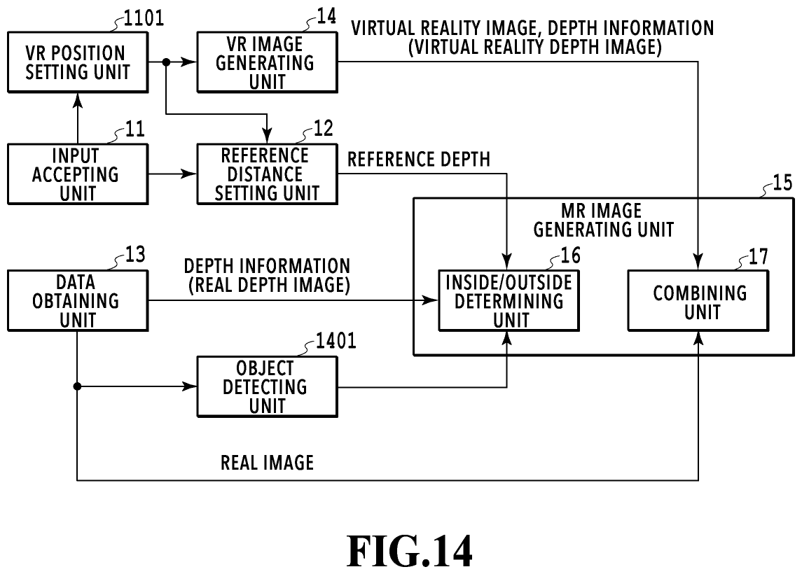

FIG. 14 is a functional block diagram showing a software configuration (logical configuration) of the image processing apparatus 20 according to the present embodiment. A major difference from the functional block diagram of FIG. 11 of the second embodiment is that an object detecting unit 1401 is added. The object detecting unit 1401 performs a process of detecting a real object from an input real image. Positional information on the detected real object is output to the inside/outside determining unit 16 of the MR image generating unit 15.

### Operation Flow of Image Processing Apparatus

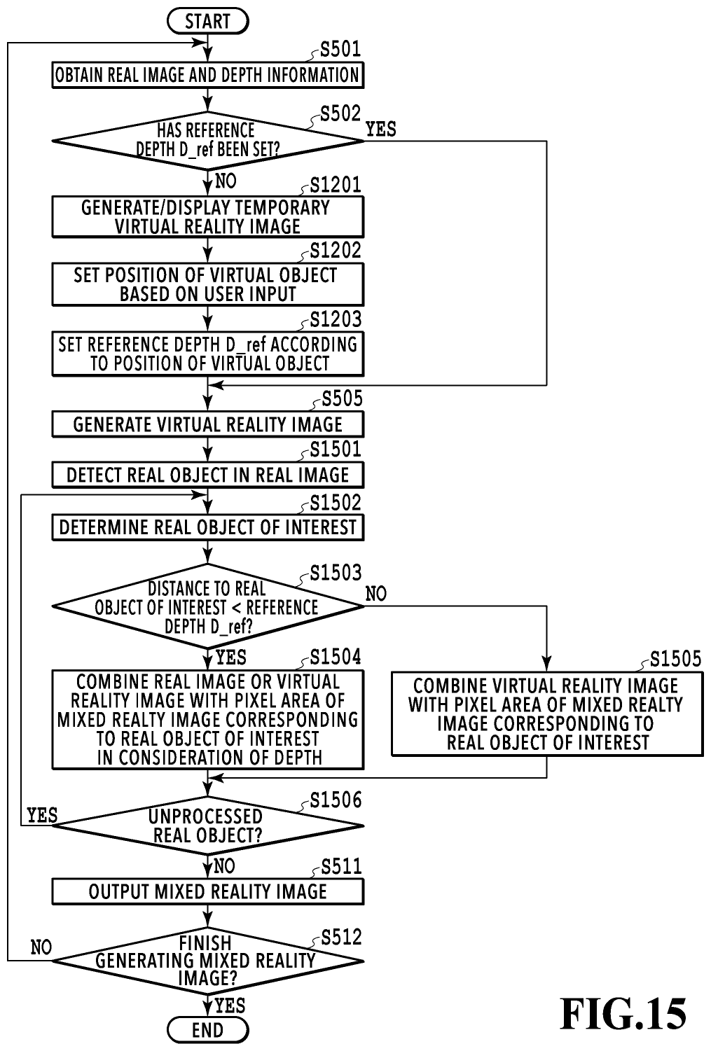

FIG. 15 is a flowchart showing a process flow of generation of a mixed reality image in the image processing apparatus 20 according to the present embodiment. A difference from the flowchart of FIG. 12 of the second embodiment is that S1501 to S1506 are executed instead of S506 to S510 and the other common steps are denoted by the same numbers. S1501 to S1506 making the difference are described below.

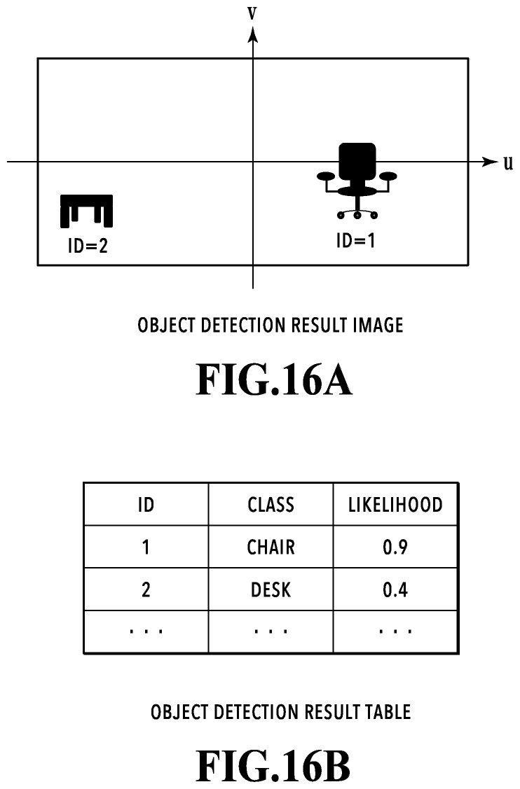

In S1501, the object detecting unit 1401 applies a well-known object detection process to a real image obtained in S501, detects a real object seen in the real image, and generates an image (hereinafter referred to as “object detection result image”) showing the detection result. FIG. 16A is a diagram showing an example of the object detection result image. The object detection result image is equal in size to the real image and has the width w and the height h. The object detection result image stores an ID which uniquely indicates each detected real object in a pixel position corresponding to each pixel of the real image. In the example of FIG. 16A, two black pixel clusters indicate detected real objects; the black pixel cluster with ID=1 indicates a chair, the black pixel cluster with ID=2 indicates a desk, and white pixels indicate a non-detected area. The object detecting unit 1401 also generates a table as shown in FIG. 16B (hereinafter referred to as “object detection result table”) in which an ID assigned to each detected real object is associated with a type (class) and likelihood of the real object. Incidentally, it is preferable to exclude a ceiling, wall, floor, ground, and the like from the subjects of object detection. This is because in a case where such large real objects are included in the subjects of object detection, even part of the real objects occupies the large part of the screen and almost all the objects in the real space are displayed in the mixed reality image. Alternatively, such objects may be included in the subjects of object detection, three-dimensional shape information on detected real objects may be obtained, and a real object greater than a predetermined size may be excluded from the mixed reality image and the object detection result table based on geometric information such as a volume, area, and length. Data on the generated object detection result image and object detection result table is stored in the RAM 102. Incidentally, although the following S1502 to S1504 are described as being executed for each real object for convenience of explanation, the process is actually executed for each pixel.

In S1502, a real object of interest out of all the detected real objects is determined. In S1503, the inside/outside determining unit 16 determines, based on the above object detection result image and real depth image, whether the real object of interest exists within or beyond the reference depth D_ref. Specifically, a pixel area of the object detection result image in which an ID of the real object of interest is stored is first specified. For the specified pixel area, a pixel value in the real depth image is compared with the value of the reference depth D_ref to determine whether the value of the reference depth D_ref is greater. As a result of determination, in a case where the pixel value in the real depth image is equal to or less than value of the reference depth D_ref, S1504 is executed next. In a case where the pixel value stored in the pixel position of interest (ui, vi) in the real depth image is greater than the value of the reference depth D_ref, S1505 is executed next.

In S1504, the combining unit 17 determines a color value in the pixel area of the real object of interest in the mixed reality image through a combining process in consideration of the depth. Specifically, for the pixel area of the object detection result image in which the ID of the real object of interest is stored, the pixel value (distance value) of the real depth image is compared with the pixel value (distance value) of the virtual reality depth image. In a case where the pixel value of the real depth image is less, the color value of the real image is stored as a color value in the corresponding pixel position in the mixed reality image in progress in the buffer. In contrast, in a case where the pixel value of the virtual reality depth image is less, the color value of the virtual reality image is stored as a color value in the corresponding pixel position in the mixed reality image in progress in the buffer. In a case where the distance values are equal to each other, it is only required that which of the color value of the real image and the color value of the virtual reality image should be adopted be determined in advance and the process be performed according to the determination.

In S1505, the combining unit 17 determines a color value of the pixel area of the real object of interest in the mixed reality image through a combining process not in consideration of the depth. In the combining process not in consideration of the depth, a virtual object in the virtual reality image is always rendered. As a specific content of the process, the color value of the virtual reality image is stored as a color value of the corresponding pixel area in the mixed reality image in progress in the buffer.

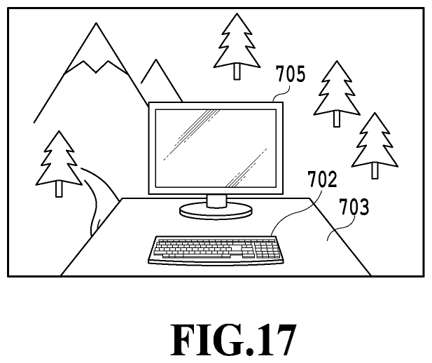

In S1506, it is determined whether all the real objects detected in S1501 have been processed. As a result of determination, in a case where there is an unprocessed real object, the process returns to S1502 and the next real object of interest is determined, followed by the same process. In contrast, in a case where all the real objects have been processed, S511 is executed next. FIG. 17 is a diagram showing a mixed reality image according to the method of the present embodiment, which is a mixed reality image obtained by combining the real image of FIG. 7A with the virtual reality image of FIG. 7B described above. As compared with the mixed reality image of FIG. 7C described above, it can be seen that the desk 703 is entirely rendered in the mixed reality image of FIG. 17. The mixed reality image thus generated is displayed in S511. This is the end of the content of the present embodiment.

### Modification Example 1

For example, in the scene of FIG. 7A described above, there may be a case where the desk 703 is partially within the reference depth, while the keyboard 702 or document (not shown) placed on the desk 703 is beyond the reference depth. Applying the present embodiment to such a case incurs a possibility that an ID different from that of the desk 703 may be assigned to the keyboard 702 or document and, depending on the reference depth, the document or keyboard 702 on the desk may be hidden while the desk 703 is entirely displayed. In this case, it is considered preferable that what is placed on the desk 703 be also displayed. Thus, in order to save a wearer's performing adjusting operation therefor, in a case where a specific real object within the reference depth is entirely displayed, other real objects placed above or below the specific real object may also be displayed together. Further, in order to obtain such a mixed reality image, for example, a specific real object within the reference depth and real objects above or below the specific real object may be integrated by a well-known clustering technique and treated as a single real object. Further, regarding real objects treated as exceptions such as a ceiling, wall, floor, and ground, even in a case where they are partially included above or below, the method of the first or second embodiment may be applied to display only part of the objects within the reference depth instead of entirely displaying the objects.

### Modification Example 2

The above embodiment has described an example of enabling display of an entire real objet as long as the real object is even partially within the reference depth. However, a real object may be prevented from being displayed even partially unless the real object is entirely within the reference depth. This can also avoid the real object from being broken in midstream. In this case, it is only necessary to determine whether pixel values of the real depth image corresponding to a pixel area of the object detection result image in which an ID of a real object of interest is stored are all equal to or greater than the value of the reference depth. Alternatively, the determination may be based on a pixel value of a representative point in the pixel area in which the ID of the real object of interest is stored.

As described above, according to the present embodiment, display of a real object at the boundary of the reference depth can be prevented from being broken in midstream in the mixed reality image.

### Fourth Embodiment

A distance to a real object changes with a wearer's motion. Thus, in the methods of the first and second embodiments, a part of a real object located almost at the boundary of the reference depth is switched between display and non-display in a mixed reality image only by slight motion of a wearer. Further, in the method of the third embodiment in which a real object is entirely displayed as long as the real object is within the reference depth even partially, the entire real object is switched between display and non-display depending on a wearer's motion. Such flicker of a real object in a mixed reality image seriously disturbs a wearer's immersion or concentration. Thus, an aspect of preventing, in a case where the reference depth is set once, switching between display/non-display of a real object until a new reference depth is set again is described as the fourth embodiment. Incidentally, since the hardware configurations of the HMD 10 and the image processing apparatus 20 and the like are the same as those of the first to third embodiments, the description thereof is omitted and a difference is mainly described below. Further, although a difference on the basis of the third embodiment is described below, it is also applicable on the basis of the first and second embodiments (including the modification examples).

### Software Configuration of Image Processing Apparatus

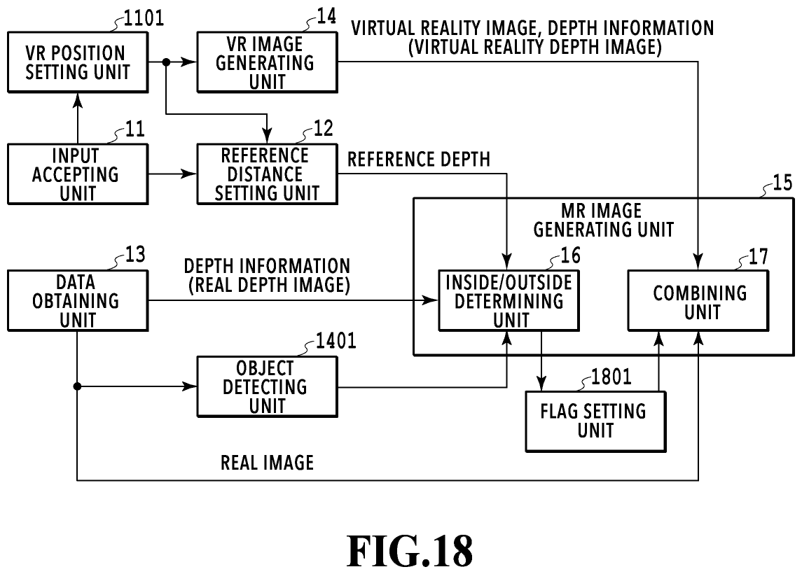

FIG. 18 is a functional block diagram showing a software configuration (logical configuration) of the image processing apparatus 20 according to the present embodiment. A major difference from the functional block diagram of FIG. 14 of the third embodiment is that a flag setting unit 1801 is added. The flag setting unit 1801 performs a process of setting a display flag as information indicating that a real object determined to be within the reference depth is displayed in a mixed reality image. The set flag information is output to the combining unit 17.

### Operation Flow of Image Processing Apparatus

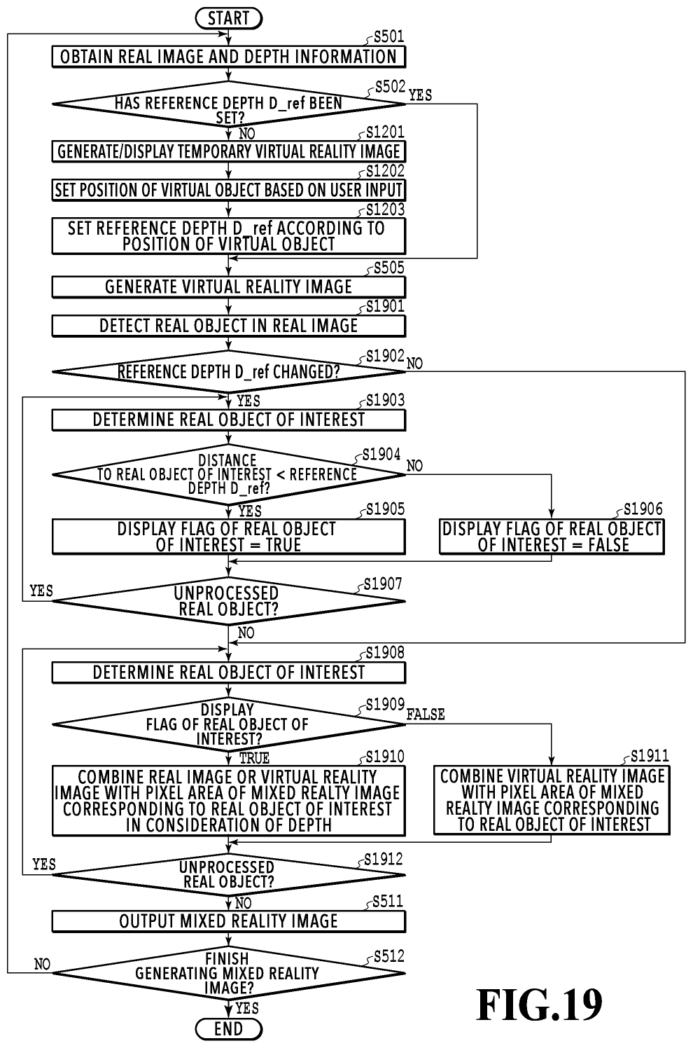

FIG. 19 is a flowchart showing a process flow of generation of a mixed reality image in the image processing apparatus 20 according to the present embodiment. A difference from the flowchart of FIG. 15 of the third embodiment is that S1901 to S1912 are executed instead of S1501 to S1506 and the other common steps are denoted by the same numbers. S1901 to S1912 making the difference are described below.

In S1901, like S1501 described above, the object detecting unit 1401 applies a well-known object detection process to a real image obtained in S501, detects a real object seen in the real image, and generates an object detection result image and an object detection result table.

In S1902, the inside/outside determining unit 16 determines whether the reference depth has been changed after the previous process. For example, it is determined whether a value of the reference depth of the previous frame stored in the RAM 102 or the like is equal to a value of the reference depth of the current frame. In a case where the reference depth has been changed, S1903 is executed next. In contrast, in a case where there is no change, S1908 is executed next. Incidentally, since there is no previous frame immediately after the start of this flow, S1902 is skipped and S1908 is immediately executed.

In S1903, a real object of interest out of all real objects detected in S1901 is determined. In S1904, the inside/outside determining unit 16 determines, based on the above object detection result image and real depth image, whether the real object of interest exists within or beyond the reference depth D_ref. The result of determination is sent to the flag setting unit 1801. In a case where the real object of interest exists within the reference depth D_ref, S1905 is executed. In a case where the real object of interest exists beyond the reference depth D_ref, S1906 is executed.

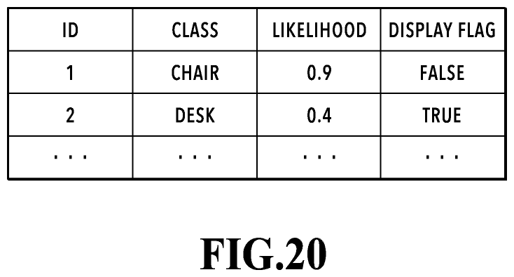

In S1905, the flag setting unit 1801 sets a value of a display flag corresponding to the real object of interest at “TRUE” which means making the real object visible. In S1906, the flag setting unit 1801 sets the value of the display flag corresponding to the real object of interest at “FALSE” which means making the real object invisible. The display flag thus set is stored by, for example, adding a “display flag” column to the object detection result table as shown in FIG. 20. Incidentally, the initial value of the display flag is “FALSE.”

In S1907, it is determined whether all the real objects detected in S1901 have been processed. As a result of determination, in a case where there is an unprocessed real object, the process returns to S1903 and the next real object of interest is determined, followed by the same process. In contrast, in a case where all the real objects have been processed, S1908 is executed next.

In S1908, a real object of interest out of all real objects detected in S1901 is determined. In S1909, a process to be executed next is determined according to the value of the display flag of the real object of interest. In a case where the value of the display flag is “TRUE,” S1910 is executed next. In a case where the value of the display flag is “FALSE,” S1911 is executed next.

In S1910, like S1504 described above, the combining unit 17 determines a color value in the pixel area of the real object of interest in the mixed reality image through a combining process in consideration of the depth. In S1911, like S1505 described above, the combining unit 17 determines a color value of the pixel area of the real object of interest in the mixed reality image through a combining process not in consideration of the depth.

In S1912, like S1506 described above, it is determined whether all the real objects detected in S1901 have been processed. As a result of determination, in a case where there is an unprocessed real object, the process returns to S1908 and the next real object of interest is determined, followed by the same process. In contrast, in a case where all the real objects have been processed, S511 is executed next. This is the end of the content of the present embodiment.

As described above, according to the present embodiment, a real object can be prevented from being frequently switched between display and non-display depending on a wearer's motion.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, a wearer's concentration and immersion can be improved in a mixed reality image using a see-through HMD.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-102924, filed Jun. 26, 2024 which is hereby incorporated by reference wherein in its entirety.

What is claimed is:

1. An image processing apparatus generating a mixed reality image which is obtained by combining a real image with a virtual reality image and is displayed on a see-through captured image display device worn on a person's head, the image processing apparatus comprising:
one or more memories storing instructions; and
one or more processors executing the instructions to:
accept an instruction from a wearer who wearing the see-through captured image display;
determine, based on the instruction from the wearer, an area of the mixed reality image in which a real object seen in the real image is visible; and
generate the mixed reality image by combining the real image with the virtual reality image according to the determined area.

2. The image processing apparatus according to claim 1,
the one or more processors executing the instructions to:
set, based on the instruction from the wearer, a reference depth which allows the real object seen in the real image to be visible in the mixed reality image; and
obtain depth information which indicates a distance between the wearer and the real object seen in the real image,
wherein the area is determined based on a result of comparison between a distance indicated by the reference depth and the distance indicated by the depth information.

3. The image processing apparatus according to claim 2, wherein
in the generation,
in a case where the distance indicated by the depth information is less than the distance indicated by the reference depth, the mixed reality image in which the real object seen in the real image is visible is generated, and
in a case where the distance indicated by the depth information is greater than the distance indicated by the reference depth, the mixed reality image in which the real object seen in the real image is invisible is generated.

4. The image processing apparatus according to claim 2, wherein
in the generation,
regarding a real object at the distance indicated by the depth information less than the distance indicated by the reference depth, the mixed reality image is generated by performing combining such that either one of the real object and a virtual object seen in the virtual reality image closer to the wearer in an eye direction of the wearer is visible, and
regarding a real object at the distance indicated by the depth information greater than the distance indicated by the reference depth, the mixed reality image is generated by performing combining such that the virtual object seen in the virtual reality image is visible while the real object in the eye direction of the wearer is invisible.

5. The image processing apparatus according to claim 4, wherein
in the setting of the reference depth,
a position of the virtual object is set based on an instruction from the wearer, and
the reference depth is set based on a distance between the wearer and the position of the virtual object.

6. The image processing apparatus according to claim 5, wherein
in the setting of a position of the virtual object,
a position of the real object is specified based on an instruction from the wearer, and
the position of the virtual object is set based on the specified position of the real object, and
in the setting of the reference depth,
the reference depth is set based on the distance between the wearer and the position of the virtual object.

7. The image processing apparatus according to claim 5, wherein
in the setting of the reference depth, the reference depth is set by adding or subtracting a distance according to an instruction from the wearer to or from the distance between the wearer and the position of the virtual object.

8. The image processing apparatus according to claim 2,
the one or more processors executing the instructions to:
accept, from the wearer, designation of a real object which needs to be visible in the mixed reality image out of real objects seen in the real image; and
set, in the setting of the reference depth, a distance between the wearer and the real object designated by the wearer as the reference depth.

9. The image processing apparatus according to claim 2,
the one or more processors executing the instructions to:
detect real objects from the real image,
wherein in the generation, in a case where a distance indicated by the depth information on a part of a real object of interest out of the detected real objects is less than the distance indicated by the reference depth, the mixed reality image in which the real object of interest seen in the real image is entirely visible is generated.

10. The image processing apparatus according to claim 2,
the one or more processors executing the instructions to:
detect real objects from the real image,
wherein in the generation, in a case where a distance indicated by the depth information on a part of a real object of interest out of the detected real objects is less than the distance indicated by the reference depth, the mixed reality image is generated by performing combining such that either one of the real object seen in the real image and a virtual object seen in the virtual reality image closer to the wearer is entirely visible.

11. The image processing apparatus according to claim 2,
the one or more processors executing the instructions to:
detect real objects from the real image,
wherein in the generation, in a case where a distance indicated by the depth information on an entire real object of interest out of the detected real objects is less than the distance indicated by the reference depth, the mixed reality image in which the real object of interest seen in the real image is entirely visible is generated.

12. The image processing apparatus according to claim 10, wherein
in the generation, the mixed reality image in which other real objects placed below or above the real object of interest which is made entirely visible in the combining are also visible is generated.

13. The image processing apparatus according to claim 2, wherein
in the generation, in a case where the reference depth is set once, the mixed reality image is generated without changing the real object which is made visible until a new reference depth is set again.

14. The image processing apparatus according to claim 2, wherein
the distance indicated by the reference depth is a distance in each of an x axis, a y axis, and a z axis expressed in a camera coordinate system having the z axis in a forward direction, the y axis in a vertical direction, and the x axis in a horizontal direction relative to the wearer.

15. The image processing apparatus according to claim 2, wherein
the distance indicated by the reference depth is a distance in an x axis and a z axis expressed in a camera coordinate system having the z axis in a forward direction, a y axis in a vertical direction, and the x axis in a horizontal direction relative to the wearer.

16. The image processing apparatus according to claim 2, wherein
the distance indicated by the reference depth is a distance in a z axis expressed in a camera coordinate system having the z axis in a forward direction, a y axis in a vertical direction, and an x axis in a horizontal direction relative to the wearer.

17. An image processing method of generating a mixed reality image which is obtained by combining a real image with a virtual reality image and is displayed on a see-through captured image display device worn on a person's head, the image processing method comprising the steps of:
accepting an instruction from a wearer who wearing the see-through captured image display;
determining, based on the instruction from the wearer, an area of the mixed reality image in which a real object seen in the real image is visible; and
generating the mixed reality image by combining the real image with the virtual reality image according to the determined area.

18. A non-transitory computer readable storage medium storing a program for causing a computer to perform an image processing method of generating a mixed reality image which is obtained by combining a real image with a virtual reality image and is displayed on a see-through captured image display device worn on a person's head, the image processing method comprising the steps of:
accepting an instruction from a wearer who wearing the see-through captured image display;
determining, based on the instruction from the wearer, an area of the mixed reality image in which a real object seen in the real image is visible; and
generating the mixed reality image by combining the real image with the virtual reality image according to the determined area.
